(19) United States
(12) Patent Application Publication
(10) Pub. No.: US 2026/0346067 A1
(43) Pub. Date: Nov. 5, 2026

(54) FIRE BLANKET ROLLER SYSTEM FOR ELECTROCHEMICAL CELL ASSEMBLIES

(71) Applicant: Atieva, Inc., Newardk, CA (US)

(72) Inventors: James A. McDaniel, San Francisco, CA (US); Quirino Cabrera, JR., Scottsdale, AZ (US)

(21) Appl. No.: 19/198,551

(22) Filed: May 5, 2025

(51) Int. Cl. A62C 8/06; A62C 3/16

(52) U.S. Cl. CPC A62C 8/06; A62C 3/16

(57) ABSTRACT

A fire blanket roller system comprises: a fire blanket roll comprising a rolled-up fire blanket; and a fire blanket roller device configured to position the fire blanket roll adjacent an electrochemical cell assembly placed on a cart or table, the fire blanket roller device comprising: an axle extending through a center of the fire blanket roll and having a first end and a second end, the axle positioned substantially in a horizontal direction at a greater height than the electrochemical cell assembly placed on the cart or table; a stand that supports the first end of the axle using a first rotational bearing, and that supports the second end of the axle using a second rotational bearing; and a handle attached to the first end or the second end of the axle for rotating the axle when loading the fire blanket onto the fire blanket roller device.

### TECHNICAL FIELD

This document relates to a fire blanket roller system for electrochemical cell assemblies.

### BACKGROUND

Rechargeable batteries based on electrochemical cells may in some circumstances be prone to thermal runaway, an event that occurs when a battery's internal reaction rate increases to such an extent that it is generating more heat than can be withdrawn. Thermal runaway may be the result of a battery short, a manufacturing defect, improper cell use, or damage. If the reaction rate and the generation of heat go unabated during the thermal runaway event, eventually the generated heat becomes great enough to cause the battery and materials in proximity to the battery to combust. Therefore, when the battery undergoing thermal runaway is located within a battery pack containing tens, hundreds or thousands of cells, a single event can quickly propagate throughout the pack, increasing the likelihood of damage and injury.

### SUMMARY

In an aspect, a fire blanket roller system comprises: a fire blanket roll comprising a fire blanket that has been rolled up; and a fire blanket roller device holding the fire blanket roll, the fire blanket roller device configured to position the fire blanket roll adjacent an electrochemical cell assembly placed on a cart or table, the fire blanket roller device comprising: an axle that extends through a center of the fire blanket roll, the axle having a first end and a second end opposite to the first end, the axle positioned substantially in a horizontal direction at a greater height than the electrochemical cell assembly placed on the cart or table; a stand that supports the first end of the axle using a first rotational bearing, and that supports the second end of the axle using a second rotational bearing; and a handle attached to the first end or the second end of the axle for rotating the axle when loading the fire blanket onto the fire blanket roller device.

Implementations can include any or all of the following features. The stand comprises a first stand on which the first rotational bearing is mounted, and a second stand on which the second rotational bearing is mounted. The first stand comprises a first post on which the first rotational bearing is mounted, and a first foot supporting the first post. The first stand further comprises a first brace connecting the first post and the first foot with each other. The second stand comprises a second post on which the second rotational bearing is mounted, and a second foot supporting the second post. The second stand further comprises a second brace connecting the second post and the second foot with each other. The first stand rests on first swivel wheels. The second stand rests on second swivel wheels. The fire blanket roller system further comprises a push handle attached to at least one of the first stand or the second stand for moving the fire blanket roller system. The push handle is attached to the first stand, and wherein the handle is attached to the second end of the axle. The fire blanket roller system further comprises a floor brake mounted to at least one of the first stand or the second stand for immobilizing the fire blanket roller system. The stand is attached to at least one base. The at least one base is configured for attaching the fire blanket roller system to a surface. The fire blanket has a rectangular shape. The fire blanket is rolled up around the axle starting with a first short side of the rectangular shape, and wherein a second short side of the rectangular shape opposite from the first short side is outermost on the fire blanket roll. The fire blanket has a fold parallel with a first long side of the rectangular shape and with a second long side of the rectangular shape opposite from the first long side. The first short side and the second short side define a width of the fire blanket; the fold comprises a first fold and a second fold both being parallel with the first long side and the second long side; the first fold is located about one quarter of the width from the first long side and forms a first fold-over portion of the fire blanket that extends from the first short side to the second short side; and the second fold is located about one quarter of the width from the second long side and forms a second fold-over portion of the fire blanket that extends from the first short side to the second short side. The fire blanket roller system further comprises: a first handle attached to the first fold-over portion at the second short side of the rectangular shape; and a second handle attached to the second fold-over portion at the second short side of the rectangular shape.

### BRIEF DESCRIPTION OF DRAWINGS

FIG. 1 shows an example of a fire blanket roller system including a fire blanket roller device and a fire blanket roll.

FIG. 2 shows another example of a fire blanket roller device.

FIG. 3 shows an example of a fire blanket that can be used in the fire blanket roll of FIG. 1.

FIG. 4A shows an example of a fire blanket roller system positioned adjacent electrochemical cell assemblies.

FIG. 4B schematically shows retrieval of the fire blanket of FIG. 4A toward either of the electrochemical cell assemblies.

FIG. 4C shows an example of the electrochemical cell assemblies covered by fire blankets.

Like reference symbols in the various drawings indicate like elements.

### DETAILED DESCRIPTION

This document describes examples of systems and techniques that provide a fire blanket roller system adjacent an electrochemical cell assembly to extinguish fire. This can be useful in a manufacturing facility that creates assemblies of electrochemical cells, or at a service facility where work is performed on battery packs (e.g., when servicing electric vehicles). Some implementations provide a roller device that is used to stage a high temperature fire blanket and that can be movable to different locations or can be permanently installed at a location where one or more electrochemical cell assemblies are nearby. A blanket is stored rolled up on the device and in the event of a thermal runaway event, the blanket can be quickly and easily unrolled by one or more persons to cover the battery pack.

As used herein, a fire blanket includes a sheet of one or more fire retardant materials, the sheet having fire retardant properties such that the fire blanket is stable in temperatures of at least 1000° C. (1832° F.). The fire blanket can include a flexible material (e.g., a fabric) treated with one or more flame retardant chemicals. The fire blanket can be relatively thick, on the order of about 1-2 inches, and can have substantial weight (e.g., about 40 pounds).

As used herein, an electrochemical cell assembly includes any assembly that includes one or more electrochemical cells. The electrochemical cell assembly can be a battery pack or a module of electrochemical cells, to name just two examples.

Examples described herein refer to a top, bottom, front, or rear. These and similar expressions identify things or aspects in a relative way based on an express or arbitrary notion of perspective. That is, these terms are illustrative only, used for purposes of explanation, and do not necessarily indicate the only possible position, direction, and so on.

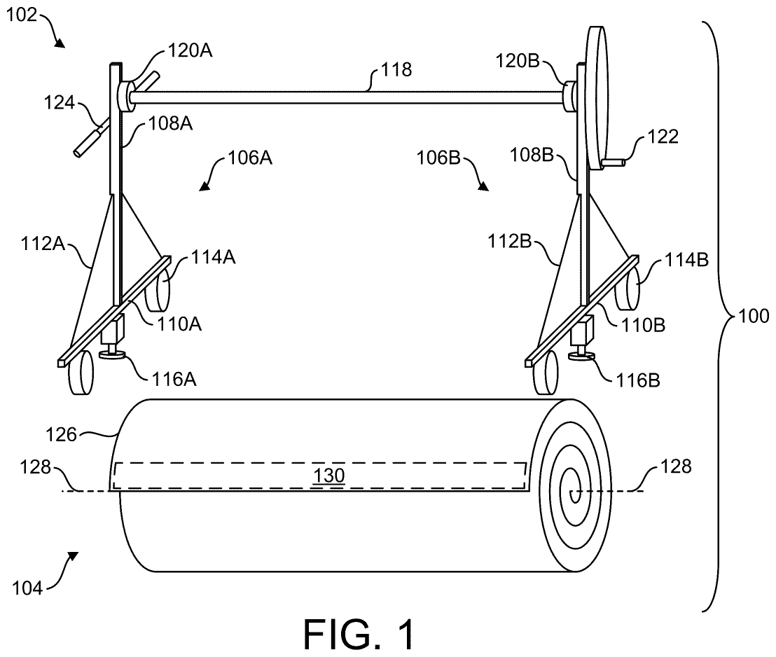

FIG. 1 shows an example of a fire blanket roller system 100 including a fire blanket roller device 102 and a fire blanket roll 104. The fire blanket roller system 100 can be used with one or more other examples described elsewhere herein.

The fire blanket roller device 102 is configured for holding the fire blanket roll 104 (which is here shown separate from the fire blanket roller device 102 for clarity) and for positioning the fire blanket roll 104 adjacent an electrochemical cell assembly placed on a cart or table. Examples are discussed below.

The fire blanket roller device 102 includes at least one stand for the fire blanket roll 104. In some implementations, the stand includes a stand 106A for one end of the fire blanket roll 104. The stand 106A can include a post 108A and a foot 110A supporting the post 108A. For example, the post 108A and the foot 110A can be hollow beams attached to each other at a right angle. The stand 106A can include at least one brace 112A connecting the post 108A and the foot 110A with each other. For example, the brace 112A can include one or more triangular metal plates attached to the post 108A and the foot 110A.

The fire blanket roller system 100 can be moveable. In some implementations, the fire blanket roller device 102 includes two or more swivel wheels 114A on which the stand 106A rests. For example, the swivel wheels 114A can be mounted to the foot 110A. The fire blanket roller device 102 can include a floor brake 116A for immobilizing the fire blanket roller system 100. For example, the floor brake 116A can be mounted to the foot 110A.

In some implementations, the stand includes a stand 106B for an opposite end of the fire blanket roll 104. The stand 106B can include a post 108B and a foot 110B supporting the post 108B. For example, the post 108B and the foot 110B can be hollow beams attached to each other at a right angle. The stand 106B can include at least one brace 112B connecting the post 108B and the foot 110B with each other. For example, the brace 112B can include one or more triangular metal plates attached to the post 108B and the foot 110B.

In some implementations, the fire blanket roller device 102 includes two or more swivel wheels 114B on which the stand 106B rests. For example, the swivel wheels 114B can be mounted to the foot 110B. The fire blanket roller device 102 can include a floor brake 116B for immobilizing the fire blanket roller system 100. For example, the floor brake 116B can be mounted to the foot 110B.

The fire blanket roller device 102 can include an axle 118 that extends through a center of the fire blanket roll 104. The fire blanket roller device 102 can be configured so that the axle 118 is positioned substantially in a horizontal direction at a greater height than the electrochemical cell assembly, for example as described below. The fire blanket roller device 102 can include a rotational bearing 120A by which the stand 106A supports one end of the axle 118. The fire blanket roller device 102 can include a rotational bearing 120B by which the stand 106B supports the opposite end of the axle 118. As such, the axle 118 is rotatably mounted to the stand of the fire blanket roller device 102 and can be free to be rotated in either or both directions. The fire blanket roller device 102 can include a handle 122 attached to either of the ends of the axle 118 for rotating the axle 118 when loading the fire blanket onto the fire blanket roller device 102. For example, the handle 122 provides a lever relative to the axle 118 so that a person can apply the necessary torque for rolling up the fire blanket.

The fire blanket roller device 102 can include a push handle 124 for moving the fire blanket roller system 100. In some implementations, the push handle 124 is attached to an opposite side of the fire blanket roller device 102 than the handle 122. For example, the push handle 124 can be attached to the stand 106A (e.g., to the post 108A) and the handle 122 can be attached to the end of the axle 118 supported by the stand 106B.

The fire blanket roll 104 is formed by rolling up a fire blanket 126 about an axis 128. For example, the fire blanket 126 can be rolled up by spooling the fire blanket 126 onto the axle 118, and the axle 118 can then coincide with the axis 128. The fire blanket 126 can be formed from a fire retardant material having a rectangular shape with two long sides opposite each other, and two short sides opposite each other and perpendicular to each of the two long sides. The fire blanket 126 can be rolled up around the axle 118 starting with one of the short sides. When the fire blanket roll 104 has thus been formed, the opposite short side is outermost on the fire blanket roll 104. This can provide an area 130 of the fire blanket 126 that facilitates grasping by a person in order to unroll the fire blanket 126 from the fire blanket roller device 102. The area 130 may or may not be provided with a handle.

The above examples illustrate that a fire blanket roller system (e.g., the fire blanket roller system 100) can include: a fire blanket roll (e.g., the fire blanket roll 104) comprising a fire blanket (e.g., the fire blanket 126) that has been rolled up; and a fire blanket roller device (e.g., the fire blanket roller device 102) holding the fire blanket roll, the fire blanket roller device configured to position the fire blanket roll adjacent an electrochemical cell assembly placed on a cart or table, the fire blanket roller device comprising: an axle (e.g., the axle 118) that extends through a center of the fire blanket roll, the axle having a first end and a second end opposite to the first end, the axle positioned substantially in a horizontal direction at a greater height than the electrochemical cell assembly placed on the cart or table; a stand (e.g., the stand 106A and the stand 106B) that supports the first end of the axle using a first rotational bearing (e.g., the rotational bearing 120A), and that supports the second end of the axle using a second rotational bearing (e.g., the rotational bearing 120B); and a handle (e.g., the handle 122) attached to the first end or the second end of the axle for rotating the axle when loading the fire blanket onto the fire blanket roller device.

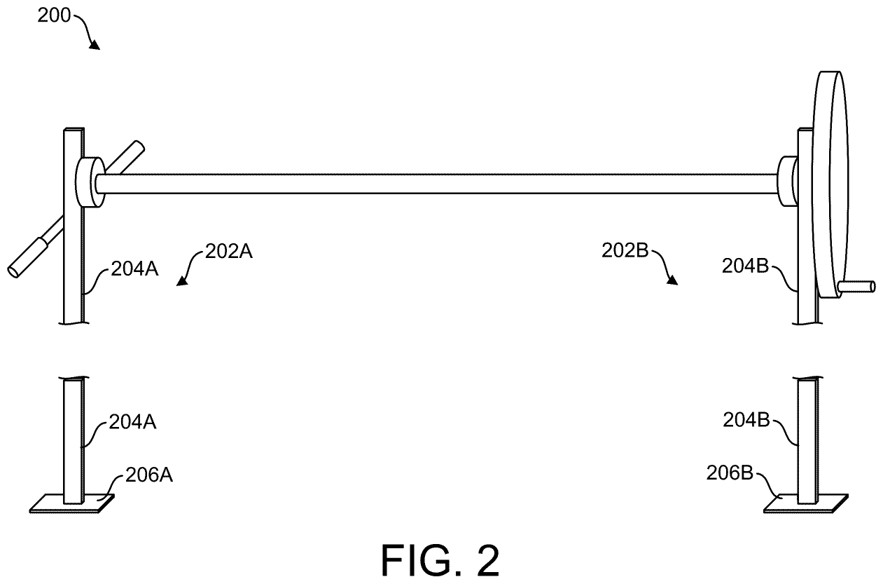

FIG. 2 shows another example of a fire blanket roller device 200. The fire blanket roller device 200 can be used with one or more other examples described elsewhere herein. The fire blanket roller device 200 can use one or more components of the fire blanket roller device 102 of FIG. 1, which components are not explicitly described in the following.

The fire blanket roller device 200 includes at least one stand for the fire blanket roll 104 of FIG. 1. In some implementations, the stand includes a stand 202A for one end of the fire blanket roll 104. The stand 202A can include a post 204A and a base 206A to which the post 204A is attached. For example, the post 204A can be a hollow beam and the base 206A can be a plate or pedestal.

In some implementations, the stand includes a stand 202B for an opposite end of the fire blanket roll 104 of FIG. 1. The stand 202B can include a post 204B and a base 206B to which the post 204B is attached. For example, the post 204B can be a hollow beam and the base 206B can be a plate or pedestal.

The stand facilitates that the fire blanket roller device 200 positions the fire blanket at a greater height than the electrochemical cell assembly. In some implementations, the bases 206A and 206B are configured for attaching the fire blanket roller device 200 to a surface. For example, the surface can be substantially horizontal (e.g., a floor) or substantially vertical (e.g., a wall). As such, the length chosen for the posts 204A and 204B can depend on the orientation that the fire blanket roller device 200 is to have when installed.

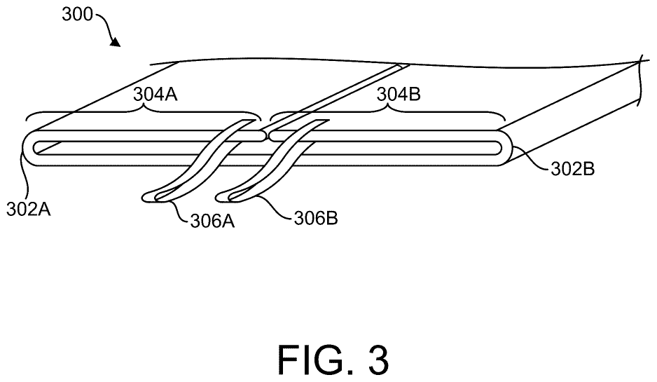

FIG. 3 shows an example of a fire blanket 300 that can be used for the fire blanket roll of FIG. 1. The fire blanket 300 can be used with one or more other examples described elsewhere herein. The fire blanket 300 is partially shown in an unrolled state for simplicity, and only one end of the fire blanket 300 that would be outermost after the fire blanket 300 is rolled up is visible in the illustration.

The fire blanket 300 can be formed from a fire retardant material having a rectangular shape with two long sides opposite each other, and two short sides opposite each other and perpendicular to each of the two long sides. In this example, the two short sides define the width of the fire blanket 300 and one of the short sides is currently situated nearest the viewer in the illustration. The fire blanket 300 can be rolled up around the axle 118 of FIG. 1 starting with one of the short sides (e.g., the short end that is not visible in FIG. 3). When the fire blanket roll 104 of FIG. 1 has thus been formed, the opposite short side (e.g., the short end that is visible in FIG. 3) can be outermost on the fire blanket roll 104.

The fire blanket 300 can be folded before being rolled up. For example, the fire blanket 300 can have a fold that is parallel with the long sides of the rectangular shape. Here, the fire blanket 300 has a fold 302A that is parallel with the long sides of the rectangular shape. The fold 302A is located about one quarter of the width of the fire blanket 300 from the first long side. The fold 302A forms a fold-over portion 304A of the fire blanket 300. The fold-over portion 304A extends along the entire length of the fire blanket 300, from the first short side to the second short side. The fire blanket 300 has a handle 306A attached to the fold-over portion 304A at the outermost short end. The handle 306A can be grasped by a person and be pulled for unrolling the fire blanket 300 from the axle 118 of FIG. 1 and for unfolding the fire blanket 300 to its full width (e.g., unfolding the fold-over portion 304A).

Here, the fire blanket 300 has a fold 302B that is parallel with the long sides of the rectangular shape. The fold 302B is located about one quarter of the width of the fire blanket 300 from the second long side. The fold 302B forms a fold-over portion 304B of the fire blanket 300. The fold-over portion 304B extends along the entire length of the fire blanket 300, from the first short side to the second short side. The fire blanket 300 has a handle 306B attached to the fold-over portion 304B at the outermost short end. The handle 306B can be grasped by a person and be pulled for unrolling the fire blanket 300 from the axle 118 of FIG. 1 and for unfolding the fire blanket 300 to its full width (e.g., unfolding the fold-over portion 304B).

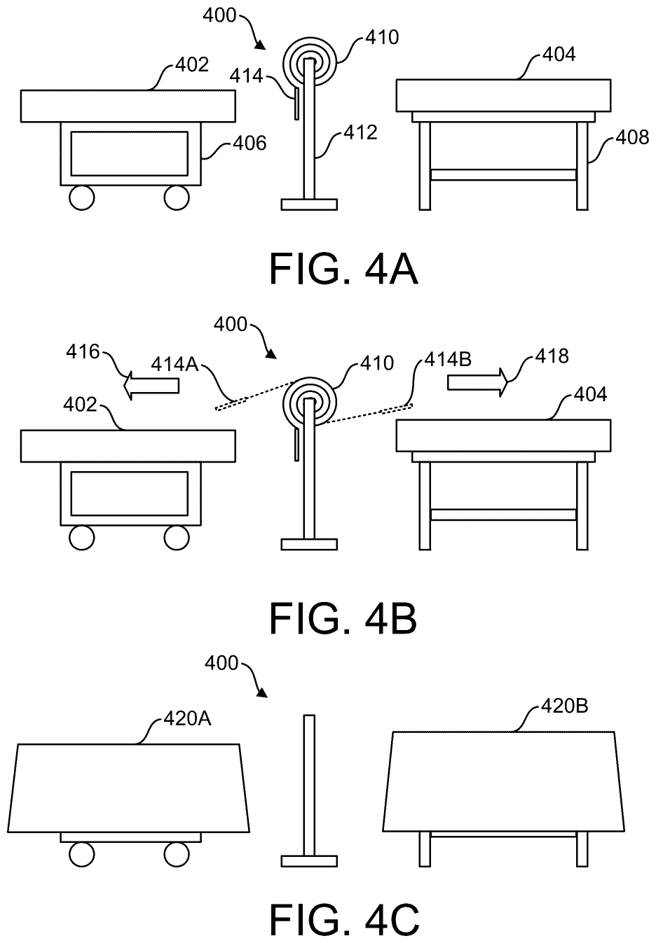

FIG. 4A shows an example of a fire blanket roller system 400 positioned adjacent electrochemical cell assemblies 402 and 404. The fire blanket roller system 400 can be used with one or more other examples described elsewhere herein. Each of the electrochemical cell assemblies 402 and 404 is an assembly of one or more electrochemical cells. For example, either or both of the electrochemical cell assemblies 402 and 404 can include a battery pack or a battery module. The electrochemical cell assemblies 402 is here placed on a cart 406 that may be manually or robotically moved around the premises during the course of work being performed. The electrochemical cell assembly 404 is placed on a table 408 (e.g., for assembly, service or disassembly). The fire blanket roller system 400 includes a fire blanket roll 410 supported by a stand 412, the fire blanket roll 410 being a rolled-up fire blanket corresponding to the fire blanket 126 of FIG. 1 or the fire blanket 300 of FIG. 3, to name just two examples. In this example, the stand 412 rests on a horizontal surface and in other examples could be mounted to a wall or other elevated structure. The fire blanket roll 410 has a handle 414 attached at an outermost end of the rolled-up fire blanket.

In this scenario, a possible thermal event in one of the electrochemical cell assemblies 402 and 404 is detected. The detection can be made by a person (e.g., visually observing indications of a thermal anomaly) or by an automated detection system that then issues an alarm or alert. In response to the detection, a person can make use of the fire blanket roller system 400 to suppress or extinguish any fire in the electrochemical cell assemblies 402 or 404. Particularly, the person can conveniently retrieve the fire blanket from the fire blanket roller system 400 and cover the electrochemical cell assembly 402 or 404 as necessary.

FIG. 4B schematically shows retrieval of the fire blanket roll of FIG. 4A toward either of the electrochemical cell assemblies 402 or 404. For example, a handle 414A schematically illustrates that the person pulls the fire blanket from the fire blanket roll 410 in a direction indicated by an arrow 416 to cover the electrochemical cell assembly 402. As another example, a handle 414B schematically illustrates that the person pulls the fire blanket from the fire blanket roll 410 in a direction indicated by an arrow 418 to cover the electrochemical cell assembly 404. Because the fire blanket roller system 400 places the fire blanket roll 410 at a greater height than the electrochemical cell assemblies 402 and 404, the action of pulling the fire blanket from the fire blanket roll 410 is swift and expedient. The person is therefore able to efficiently place the fire blanket over one of the electrochemical cell assemblies 402 or 404 as needed. FIG. 4C shows an example of the electrochemical cell assemblies covered by fire blankets 420A and 420B, respectively.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one”.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A fire blanket roller system comprising:
a fire blanket roll comprising a fire blanket that has been rolled up; and
a fire blanket roller device holding the fire blanket roll, the fire blanket roller device configured to position the fire blanket roll adjacent an electrochemical cell assembly placed on a cart or table, the fire blanket roller device comprising:
an axle that extends through a center of the fire blanket roll, the axle having a first end and a second end opposite to the first end, the axle positioned substantially in a horizontal direction at a greater height than the electrochemical cell assembly placed on the cart or table;
a stand that supports the first end of the axle using a first rotational bearing, and that supports the second end of the axle using a second rotational bearing; and
a handle attached to the first end or the second end of the axle for rotating the axle when loading the fire blanket onto the fire blanket roller device.

2. The fire blanket roller system of claim 1, wherein the stand comprises a first stand on which the first rotational bearing is mounted, and a second stand on which the second rotational bearing is mounted.

3. The fire blanket roller system of claim 2, wherein the first stand comprises a first post on which the first rotational bearing is mounted, and a first foot supporting the first post.

4. The fire blanket roller system of claim 3, wherein the first stand further comprises a first brace connecting the first post and the first foot with each other.

5. The fire blanket roller system of claim 3, wherein the second stand comprises a second post on which the second rotational bearing is mounted, and a second foot supporting the second post.

6. The fire blanket roller system of claim 5, wherein the second stand further comprises a second brace connecting the second post and the second foot with each other.

7. The fire blanket roller system of claim 2, wherein the first stand rests on first swivel wheels.

8. The fire blanket roller system of claim 7, wherein the second stand rests on second swivel wheels.

9. The fire blanket roller system of claim 8, further comprising a push handle attached to at least one of the first stand or the second stand for moving the fire blanket roller system.

10. The fire blanket roller system of claim 9, wherein the push handle is attached to the first stand, and wherein the handle is attached to the second end of the axle.

11. The fire blanket roller system of claim 8, further comprising a floor brake mounted to at least one of the first stand or the second stand for immobilizing the fire blanket roller system.

12. The fire blanket roller system of claim 1, wherein the stand is attached to at least one base.

13. The fire blanket roller system of claim 12, wherein the at least one base is configured for attaching the fire blanket roller system to a surface.

14. The fire blanket roller system of claim 1, wherein the fire blanket has a rectangular shape.

15. The fire blanket roller system of claim 14, wherein the fire blanket is rolled up around the axle starting with a first short side of the rectangular shape, and wherein a second short side of the rectangular shape opposite from the first short side is outermost on the fire blanket roll.

16. The fire blanket roller system of claim 15, wherein the fire blanket has a fold parallel with a first long side of the rectangular shape and with a second long side of the rectangular shape opposite from the first long side.

17. The fire blanket roller system of claim 16, wherein:
the first short side and the second short side define a width of the fire blanket;
the fold comprises a first fold and a second fold both being parallel with the first long side and the second long side;
the first fold is located about one quarter of the width from the first long side and forms a first fold-over portion of the fire blanket that extends from the first short side to the second short side; and
the second fold is located about one quarter of the width from the second long side and forms a second fold-over portion of the fire blanket that extends from the first short side to the second short side.

18. The fire blanket roller system of claim 17, further comprising:
a first handle attached to the first fold-over portion at the second short side of the rectangular shape; and
a second handle attached to the second fold-over portion at the second short side of the rectangular shape.
